(19) United States
(12) Patent Application Publication
(10) Pub. No.: US 2026/0088843 A1
(43) Pub. Date: Mar. 26, 2026

(54) Wireless Circuitry with Local Oscillator Crosstalk Mitigation

(71) Applicant: Apple Inc., Cupertino, CA (US)

(72) Inventors: Jovan Markovic, Linz (AT); Jochen Schrattenecker, Alberndorf in der Riedmark (AT)

(21) Appl. No.: 18/898,050

(22) Filed: Sep. 26, 2024

(51) Int. Cl. H04B 1/04; H04B 1/00

(52) U.S. Cl. CPC H04B 1/0483; H04B 1/0007

(57) ABSTRACT

A transceiver may include first and second transmit chains that generate first and second radio-frequency signals at first and second frequencies using first and second local oscillator (LO) signals. A transmit chain may include a digital front end, upconversion circuitry, an adder coupled to an input of the upconversion circuitry, and first and second paths coupled between the digital front end and the adder. The first path may generate a first signal at a first sample rate. The second path may generate a second signal at a second sample rate equal to a greatest common divisor of the first and second frequencies and that is out of phase with the first signal. The adder may generate a combined signal based on the first and second signals. The upconversion circuitry may generate a radio-frequency signal based on the combined signal that is free from signal spurs associated with LO crosstalk.

### FIELD

This disclosure relates generally to electronic devices, including electronic devices with wireless communications circuitry.

### BACKGROUND

Electronic devices are often provided with wireless communications capabilities. An electronic device with wireless communications capabilities has wireless communications circuitry with one or more antennas. Transceivers circuitry in the wireless communications circuitry uses the antennas to receive and transmit radio-frequency signals.

The transceiver circuitry can convert signals between frequencies using a local oscillator signal. If care is not taken, the local oscillator signal can be susceptible to crosstalk that can deteriorate communications performance.

### SUMMARY

An electronic device may include wireless circuitry. The wireless circuitry may include a transceiver. The transceiver may include a first transmit chain and a second transmit chain. The transceiver may include local oscillator (LO) circuitry that generates a first LO signal at a first frequency and a second LO signal at a second frequency. The first transmit chain may generate a first radio-frequency signal at the first frequency using the first LO signal. The second transmit chain may generate a second radio-frequency signal at the second frequency using the second LO signal.

To mitigate LO-to-LO crosstalk in the transceiver, one or both of the transmit chains may include a digital front end, upconversion circuitry, an adder coupled to an input of the upconversion circuitry, and first and second interpolation paths coupled in parallel between the digital front end and the adder. The first interpolation path may generate a first signal at a first sample rate based on a baseband signal. The second interpolation path may generate a second signal at a second sample rate based on the baseband signal. The second sample rate may be equal to a greatest common divisor of the first and second frequencies. The second signal may be out of phase with respect to the first signal and may be power scaled to match the first signal. The adder may generate a combined signal by adding the second signal to the first signal. The upconversion circuitry may generate a radio-frequency signal based on the combined signal.

An aspect of the disclosure provides wireless circuitry. The wireless circuitry can include a digital front end configured to receive a baseband signal. The wireless circuitry can include upconversion circuitry. The wireless circuitry can include an adder coupled to an input of the upconversion circuitry. The wireless circuitry can include first and second interpolation paths coupled in parallel between the digital front end and the adder. The first interpolation path can be configured to generate a first signal at a first sample rate based on the baseband signal. The second interpolation path can be configured to generate a second signal at a second sample rate lower than the first sample rate based on the baseband signal, the second signal being out of phase with respect to the first signal. The adder can be configured to generate a combined signal based on the first and second signals. The upconversion circuitry can be configured to generate a radio-frequency signal based on the combined signal and a local oscillator signal.

An aspect of the disclosure provides a transceiver. The transceiver can include local oscillator (LO) circuitry configured to generate a first LO signal at a first frequency and a second LO signal at a second frequency different from the first frequency. The transceiver can include a first transmit chain operably coupled to the LOC circuitry and configured to generate a first radio-frequency signal at the first frequency based on the first LO signal. The transceiver can include a second transmit chain operably coupled to the LOC circuitry. The second transmit chain can include first sampling circuitry configured to generate a first signal at a first sample rate based on a baseband signal. The second transmit chain can include second sampling circuitry configured to generate a second signal at a second sample rate lower than the first sample rate based on the baseband signal, wherein the second signal is out of phase with the first signal. The second transmit chain can include an adder configured to generate a combined signal by adding the second signal to the first signal. The second transmit chain can include upconversion circuitry configured to generate a second radio-frequency signal at the second frequency based on the second LO signal and the combined signal.

An aspect of the disclosure provides a method of operating radio-frequency transceiver circuitry. The method can include transmitting, using a first transmit chain, a first radio-frequency signal at a first frequency. The method can include transmitting, using a second transmit chain, a second radio-frequency signal at a second frequency different than the first frequency. Transmitting the second radio-frequency signal can include sampling, using first interpolation circuitry, a signal at a first sample rate. Transmitting the second radio-frequency signal can include sampling, using second interpolation circuitry, the signal at a second sample rate lower than the first sample rate, wherein the signal sampled by the second interpolation circuitry is out of phase with the signal sampled by the first interpolation circuitry. Transmitting the second radio-frequency signal can include generating, using an adder, a combined signal based on the signal sampled by the first interpolation circuitry and the signal sampled by the second interpolation circuitry. Transmitting the second radio-frequency signal can include generating, using conversion circuitry, the second radio-frequency signal based on the combined signal.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having a transceiver in accordance with some embodiments.

FIG. 3 is a diagram of illustrative wireless circuitry having multiple transmit chains that transmit radio-frequency signals using local oscillator (LO) signals in accordance with some embodiments.

FIG. 4 is a circuit diagram of illustrative wireless circuitry that includes multiple transmit chains with LO crosstalk mitigation circuitry in accordance with some embodiments.

FIG. 5 is a circuit diagram of illustrative wireless circuitry having multiple transmit chains and having LO crosstalk mitigation circuitry that includes multiplexers in accordance with some embodiments.

FIG. 6 is a flow chart of illustrative operations involved in transmitting radio-frequency signals using wireless circuitry that includes LO crosstalk mitigation circuitry in accordance with some embodiments.

FIGS. 7-10 are plots illustrating the operation and performance of illustrative LO crosstalk mitigation circuitry in accordance with some embodiments.

### DETAILED DESCRIPTION

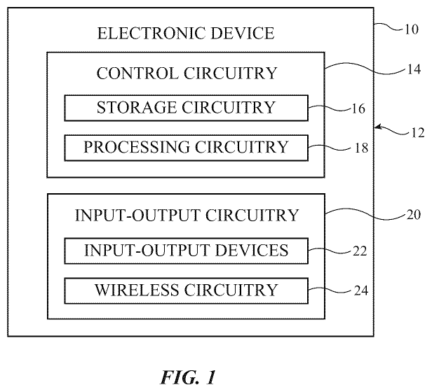

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols - sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

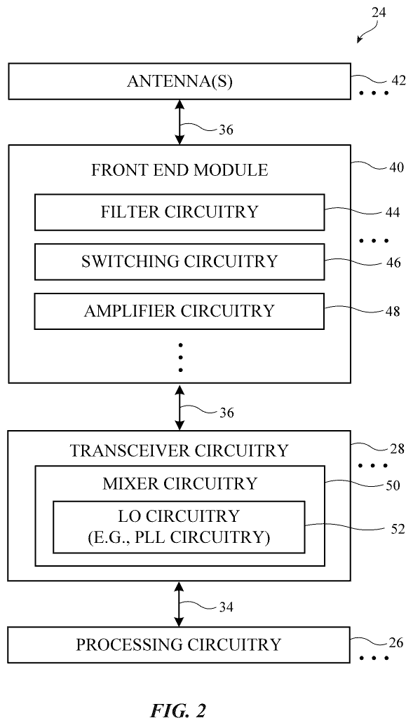

FIG. 2 is a diagram showing illustrative components within wireless circuitry 24. As shown in FIG. 2, wireless circuitry 24 may include processor circuitry such as processing circuitry 26, radio-frequency (RF) transceiver circuitry such as transceiver circuitry 28 (e.g., one or more transceivers, transmitters, and/or receivers), radio-frequency front end circuitry such as radio-frequency front end module (FEM) 40, and antenna(s) 42. Processing circuitry 26 may include a baseband processor, an application processor, a digital signal processor, a microcontroller, a microprocessor, a central processing unit (CPU), a programmable device, a combination of these circuits, and/or one or more processors within processing circuitry 18 of FIG. 1. Processing circuitry 26 may be configured to generate digital (transmit or baseband) signals. Processing circuitry 26 may be coupled to transceiver 28 over path 34 (sometimes referred to as a baseband path). Transceiver 28 may be coupled to antenna 42 via radio-frequency transmission line path 36. Radio-frequency front end module 40 may be interposed on radio-frequency transmission line path 36 between transceiver 28 and antenna 42.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

In the example of FIG. 2, wireless circuitry 24 is illustrated as including only a single unit or block of processing circuitry 26, a single transceiver 28, a single front end module 40, and a single antenna 42 for the sake of clarity. In general, wireless circuitry 24 may include any desired number of units of processing circuitry 26, any desired number of transceivers 28, any desired number of front end modules 40, and any desired number of antennas 42. Each processing processor in processing circuitry 26 may be coupled to one or more transceiver 28 over respective paths 34. Each transceiver 28 may include a transmitter circuit configured to output uplink signals to antenna 42, may include a receiver circuit configured to receive downlink signals from antenna 42, and may be communicatively coupled to one or more antennas 42 over respective radio-frequency transmission line paths 36. Each transceiver 28 may be implemented using a corresponding integrated circuit chip or package, if desired (e.g., a separate chip than is used to form baseband circuitry in processing circuitry 26 and a separate chip than is used to form a front end module 40). Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module interposed thereon.

Front end module (FEM) 40 may include radio-frequency front end circuitry that operates on the radio-frequency signals conveyed (transmitted and/or received) over radio-frequency transmission line path 36. Front end module may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and one or more low-noise amplifiers), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be interposed within radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards. In one suitable arrangement, radio-frequency transmission line paths such as radio-frequency transmission line path 36 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), a Wi-Fi® 7 band, wireless personal area network (WPAN) transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

In performing wireless transmission, processing circuitry 26 may provide digital baseband signals to transceiver 28 over path 34. Transceiver 28 may further include circuitry for converting the baseband signals received from processing circuitry 26 into corresponding intermediate frequency or radio-frequency signals. For example, transceiver circuitry 28 may include mixer circuitry 50 for up-converting (or modulating) the baseband signals to intermediate frequencies or radio frequencies prior to transmission over antenna 42. Transceiver circuitry 28 may also include digital-to-analog converter (DAC) and/or analog-to-digital converter (ADC) circuitry for converting signals between digital and analog domains. Transceiver 28 may include a transmitter component that transmits the radio-frequency signals over antenna 42 via radio-frequency transmission line path 36 and front end module 40. Antenna 42 may transmit the radio-frequency signals to external wireless equipment by radiating the radio-frequency signals into free space.

In performing wireless reception, antenna 42 may receive radio-frequency signals from the external wireless equipment. The received radio-frequency signals may be conveyed to transceiver 28 via radio-frequency transmission line path 36 and front end module 40. Transceiver 28 may include circuitry for converting the received radio-frequency signals into corresponding intermediate frequency or baseband signals. For example, transceiver 28 may use mixer circuitry 50 for down-converting (or demodulating) the received radio-frequency signals to baseband frequencies prior to conveying the received signals to processing circuity 26 over path 34. Mixer circuitry 50 may include or may otherwise be coupled to clocking circuitry such as local oscillator (LO) circuitry 52. Local oscillator circuitry 52 may generate oscillator signals (sometimes also referred to herein as local oscillator signals) that mixer circuitry 50 uses to modulate/convert transmitting signals from baseband frequencies to radio frequencies and/or to demodulate/convert the received signals from radio frequencies to baseband frequencies. LO circuitry 52 may include one or more phase-locked loops (PLLs), frequency-locked loops (FLLs), self-injection locking loops, voltage controlled oscillators (VCOs), low drop-out (LDO) regulators, crystal oscillators, reference oscillators, and/or any other desired clocking circuitry that clocks the operation of mixer circuitry 50.

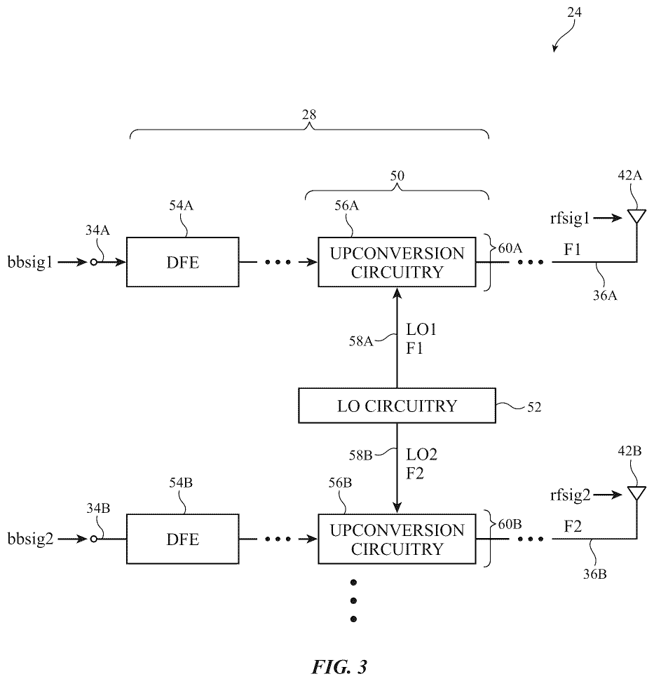

In practice, transceiver 28 (e.g., a transmitter in transceiver 28) may include different transmit chains that are each coupled to a different respective antenna 42 in wireless circuitry 24. FIG. 3 is a diagram of wireless circuitry 24 showing one example of how transceiver circuitry 28 may include multiple transmit chains coupled to different respective antennas 42. Transceiver circuitry 28 may be communicatively/operably coupled between a set of paths 34 and a set of antennas 42. Transceiver circuitry 28 may include or implement multiple transmit chains 60 that are each coupled to a respective antenna 42. Transmit chains 60 are sometimes also referred to herein as transmit (TX) paths 60 of transceiver 28.

For example, as shown in FIG. 3, transceiver circuitry 28 may include a first transmit chain 60A and a second transmit chain 60B. Transmit chain 60A may be coupled between a first baseband path 34 such as path 34A and a first radio-frequency transmission line path 36 such as radio-frequency transmission line path 36A. The input of transmit chain 60A may be coupled to path 34A. Radio-frequency transmission line path 36A may communicatively couple the output of transmit chain 60A to antenna 42A. Radio-frequency transmission line path 36A may sometimes also referred to as a part of transmit chain 60A.

Similarly, transmit chain 60B may be coupled between a second baseband path 34 such as path 34B and a second radio-frequency transmission line path 36 such as radio-frequency transmission line path 36B. The input of transmit chain 60B may be coupled to path 34B. Radio-frequency transmission line path 36B may communicatively couple the output of transmit chain 60B to antenna 42B. Radio-frequency transmission line path 36B may sometimes also referred to as a part of transmit chain 60B.

Each transmit chain 60 may include respective digital front end (DFE) circuitry 54 and respective upconversion circuitry 56 (e.g., in mixer circuitry 50 of FIG. 2) coupled between DFE circuitry 54 and the corresponding antenna 42. For example, transmit chain 60A may include DFE circuitry such as DFE 54A and upconversion circuitry 56A coupled in series between path 34A and radio-frequency transmission line path 36A. The input of DFE 54A may be coupled to path 34A. The output of DFE 54A may be coupled to the input of upconversion circuitry 56A. The output of upconversion circuitry 56A may be coupled to radio-frequency transmission line path 36A (e.g., upconversion circuitry 56A may be coupled in series between DFE 54A and radio-frequency transmission line path 36A).

Similarly, transmit chain 60B may include DFE circuitry such as DFE 54B and upconversion circuitry 56B coupled in series between path 34B and radio-frequency transmission line path 36B. The input of DFE 54B may be coupled to path 34B. The output of DFE 54B may be coupled to the input of upconversion circuitry 56B. The output of upconversion circuitry 56B may be coupled to radio-frequency transmission line path 36B (e.g., upconversion circuitry 56B may be coupled in series between DFE 54B and radio-frequency transmission line path 36B).

Both transmit chains 60A and 60B may be clocked using LO circuitry 52 via respective clocking paths 58. For example, LO circuitry 52 may generate and provide a first clock signal such as local oscillator signal LO1 to upconversion circuitry 56A over clocking path 58A. Local oscillator signal LO1 may be at frequency F1 (e.g., a carrier frequency of radio-frequency signals to be transmitted over antenna 42A). At the same time, LO circuitry 52 may generate and provide a second clock signal such as local oscillator signal LO2 to upconversion circuitry 56B over clocking path 58B. Local oscillator signal LO2 may be at frequency F2 (e.g., a carrier frequency of radio-frequency signals to be transmitted over antenna 42B).

During signal transmission, transmit chain 60A may receive a digital baseband signal such as baseband signal bbsig1 from processing circuitry 26 of FIG. 2 (e.g., from a first baseband chip in processing circuitry 26). If desired, processing circuitry 26 may modulate and/or encode baseband signal bbsig1 to include wireless data to be transmitted to external equipment (e.g., a stream of data symbols, frames, packets, datagrams, etc.). At the same time, transmit chain 60B may receive a digital baseband signal such as baseband signal bbsig2 from processing circuitry 26 of FIG. 2 (e.g., from the first baseband chip or a second baseband chip in processing circuitry 26). If desired, processing circuitry 26 may modulate and/or encode baseband signal bbsig2 to include wireless data to be transmitted to external equipment (e.g., a stream of data symbols, frames, packets, datagrams, etc.). The wireless data carried by baseband signal bbsig2 may be the same as the wireless data carried by baseband signal bbsig1 or may be different wireless data (e.g., for implementing a MIMO scheme, a carrier aggregation scheme, a diversity scheme, etc.). If desired, one or both baseband signals may include a spatial ranging waveform (e.g., a radar waveform) for use in performing radio-based spatial ranging operations, reference signal waveforms, control information, and/or any other desired information or digital waveform.

DFE 54A may include any desired digital circuitry that operates on baseband signal bbsig1 in the digital domain (e.g., sampling circuitry, digital filter circuitry, decimation circuitry, adder circuitry, digital phase shifting circuitry, digital delay circuitry, amplifier circuitry, power detector circuitry, digital attenuator circuitry, switching circuitry, etc.). DFE 54A may process and/or operate on baseband signal bbsig1 and may transmit baseband signal bbsig1 to upconversion circuitry 56A. Upconversion circuitry 56A may upconvert baseband signal bbsig1 from baseband to a radio frequency using local oscillator signal LO1.

Upconversion circuitry 56A may, for example, modulate baseband signal bbsig1 onto local oscillator signal LO1 to produce radio-frequency signal rfsig1 (e.g., including the data from baseband signal bbsig1 as modulated onto a carrier at frequency F1) on radio-frequency transmission line path 36A. If desired, transmit chain 60A may include multiple stages of upconversion circuitry (e.g., for upconverting from baseband to an intermediate frequency and then from the intermediate frequency to frequency F1). Radio-frequency transmission line path 36A carries radio-frequency signal rfsig1 to antenna 42A. Antenna 42A may transmit (radiate) radio-frequency signal rfsig1.

Transmit chain 60A may include digital-to-analog converter (DAC) circuitry within DFE 54A, within upconversion circuitry 56A, and/or coupled between DFE 54A and upconversion circuitry 56A. The DAC circuitry may convert baseband signal bbsig1 from the digital domain to the analog domain (e.g., for producing radio-frequency signal rfsig1, which is in the analog domain). In some implementations, upconversion circuitry 56A may include a DAC and a mixer coupled in series between DFE 54A and radio-frequency transmission line path 36A. In these implementations, the DAC may convert baseband signal bbsig1 to the analog domain. The mixer may have a first input that receives the analog baseband signal and may have a second input that receives local oscillator signal LO1. The mixer may mix baseband signal bbsig1 with local oscillator signal LO1 (e.g., modulating information from baseband signal bbsig1 onto a carrier at frequency F1) to produce radio-frequency signal rfsig1. In other implementations, upconversion circuitry 56A may include a radio-frequency DAC (RFDAC) that performs digital-to-analog conversion and that also upconverts baseband signal bbsig1 to frequency F1 based on local oscillator signal LO1.

Similarly, DFE 54B may include any desired digital circuitry for that operates on baseband signal bbsig2 in the digital domain (e.g., sampling circuitry, digital filter circuitry, decimation circuitry, adder circuitry, digital phase shifting circuitry, digital delay circuitry, amplifier circuitry, power detector circuitry, digital attenuator circuitry, switching circuitry, etc.). DFE 54B may process and/or operate on baseband signal bbsig2 and may transmit baseband signal bbsig2 to upconversion circuitry 56B. Upconversion circuitry 56B may upconvert baseband signal bbsig2 from baseband to a radio frequency using local oscillator signal LO2.

Upconversion circuitry 56B may, for example, modulate baseband signal bbsig2 onto local oscillator signal LO2 to produce radio-frequency signal rfsig2 (e.g., including data from the baseband signal modulated onto a carrier at frequency F2) on radio-frequency transmission line path 36B. If desired, transmit chain 60B may include multiple stages of upconversion circuitry (e.g., for upconverting from baseband to an intermediate frequency and then from the intermediate frequency to frequency F2). Radio-frequency transmission line path 36B carries radio-frequency signal rfsig2 to antenna 42B. Antenna 42B may transmit (radiate) radio-frequency signal rfsig2.

Transmit chain 60B may include digital-to-analog converter (DAC) circuitry within DFE 54B, within upconversion circuitry 56B, and/or coupled between DFE 54B and upconversion circuitry 56B. The DAC circuitry may convert baseband signal bbsig2 from the digital domain to the analog domain (e.g., for producing radio-frequency signal rfsig1, which is in the analog domain). In some implementations, upconversion circuitry 56B may include a DAC and a mixer coupled in series between DFE 54B and radio-frequency transmission line path 36B. In these implementations, the DAC may convert baseband signal bbsig2 to the analog domain. The mixer may have a first input that receives the analog baseband signal and may have a second input that receives local oscillator signal LO2. The mixer may mix baseband signal bbsig2 with local oscillator signal LO2 (e.g., modulating information from baseband signal bbsig2 onto a carrier frequency at frequency F2) to produce radio-frequency signal rfsig2. In other implementations, upconversion circuitry 56B may include a radio-frequency DAC (RFDAC) that performs digital-to-analog conversion and that also upconverts baseband signal bbsig2 to frequency F2 based on local oscillator signal LO2.

If desired, some or all of transmit chain 60B may be coextensive with (e.g., may extend along, adjacent, near, and/or parallel to) some or all of transmit chain 60A. This may, for example, help to minimize routing complexity for clocking paths 58 between LO circuitry 52 and transmit chains 60A and 60B. However, if care is not taken, in implementations where radio-frequency signal rfsig1 is at a different frequency than radio-frequency signal rfsig2 (i.e., when frequency F2 is different than frequency F1), there may be undesirable signal crosstalk between local oscillator signal LO1 and local oscillator signal LO2 (sometimes also referred to herein as LO crosstalk or LO-to-LO crosstalk between transmit chains 60A and 60B).

Instead of including only a single unmodulated signal component at frequency F1, LO-to-LO crosstalk can cause local oscillator signal LO1 to also contain multiple tones at regularly spaced frequencies other than frequency F1. Similarly, LO-to-LO cross talk can cause local oscillator signal LO2 to contain multiple tones at regularly spaced frequencies other than frequency F2 in addition to an unmodulated signal component at frequency F2. These tones are sometimes also referred to herein as LO signal spurs or spurs. The LO spurs occur at integer multiples of the greatest common divisor (divider) of frequencies F1 and F2. The LO spurs may, for example, be generated at frequencies FX given by the equation FX=±n*F1±m*F2, where n and m are integers. Adjacent spurs may be separated in frequency by a spur frequency spacing dF (sometimes also referred to herein as spur frequency offset dF) equal to the greatest common divisor of frequencies F1 and F2.

When upconversion circuitry 56A or upconversion circuitry 56B mixes a local oscillator signal containing LO crosstalk spurs with a transmit signal to produce radio-frequency signal rfsig1 or rfsig2, the spurs will also be present in the generated radio-frequency signal.

These spurs can deteriorate the radio-frequency performance of wireless circuitry 24 in transmitting signals. For example, LO crosstalk spurs in radio-frequency signals rfsig can cause wireless circuitry 24 to violate one or more limits (e.g., regulatory requirements) on radio-frequency radiation, emission, exposure, and/or absorption (e.g., maximum permissible exposure (MPE) limits, specific absorption rate (SAR) limits, emission masks, etc.), and/or may produce undesirable signal interference with other components in device 10 or external to device 10.

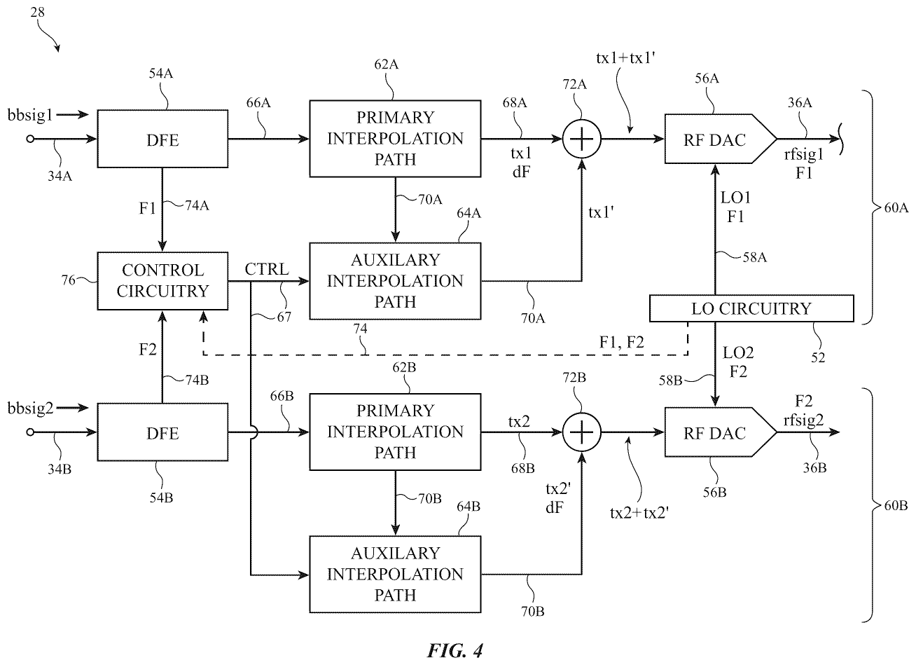

To help mitigate these issues, transceiver 28 may include LO crosstalk mitigation circuitry in transmit chains 60A and/or 60B. FIG. 4 is a circuit diagram showing one example of how transmit chains 60A and 60B may include LO crosstalk mitigation circuitry. The LO crosstalk mitigation circuitry may include, for example, a primary interpolation path 62, an auxiliary interpolation path 64, and a signal adder 72 in one or more of the transmit chains 60 of transceiver 28.

For example, as shown in FIG. 4, transmit chain 60A may include a first interpolation path such as primary interpolation path 62A, may include a second interpolation path such as auxiliary interpolation path 64A, and may include signal adding (combining) circuitry such as adder 72A (e.g., a digital adder) coupled between DFE 54A and upconversion circuitry 56A. The output of DFE 54A may be coupled to the input of primary interpolation path 62A over transmit (signal) path 66A. The output of primary interpolation path 62A may be coupled to a first input of adder 72A over transmit (signal) path 68A. Transmit path 66A and/or primary interpolation path 62A may also be coupled to a second input of adder 72A over a signal path 70A coupled between transmit path 66A and adder 72A in parallel with primary interpolation path 62A and transmit path 68A (sometimes also referred to herein as signal branch 70A or transmit path 70A). Auxiliary interpolation path 64A may be disposed on signal path 70A between primary interpolation path 62A (or transmit path 66A) and the second input of adder 72A. Adder 72A may have an output coupled to the input of upconversion circuitry 56A.

Primary interpolation path 62A may include digital circuitry and is sometimes also referred to herein as primary interpolation circuitry 62A, primary interpolation chain 62A, digital interpolation circuitry 62A, or interpolator 62A. Auxiliary interpolation path 64A may include digital circuitry and is sometimes also referred to herein as auxiliary or secondary interpolation circuitry 64A, auxiliary interpolation chain 64A, digital interpolation circuitry 64A, or interpolator 64A.

Similarly, transmit chain 60B may include a first interpolation path such as primary interpolation path 62B, may include a second interpolation path such as auxiliary interpolation path 64B, and may include signal adding (combining) circuitry such as adder 72B (e.g., a digital adder) coupled between DFE 54B and upconversion circuitry 56B. The output of DFE 54B may be coupled to the input of primary interpolation path 62B over transmit (signal) path 66B. The output of primary interpolation path 62B may be coupled to a first input of adder 72B over transmit (signal) path 68B. Transmit path 66B and/or primary interpolation path 62B may also be coupled to a second input of adder 72B over a signal path 70B coupled between transmit path 66B and adder 72B in parallel with primary interpolation path 62B and transmit path 68B (sometimes also referred to herein as signal branch 70B or transmit path 70B). Auxiliary interpolation path 64B may be disposed on signal path 70B between primary interpolation path 62B (or transmit path 66B) and the second input of adder 72B. Adder 72B may have an output coupled to the input of upconversion circuitry 56B.

Primary interpolation path 62B may include digital circuitry and is sometimes also referred to herein as primary interpolation circuitry 62B, primary interpolation chain 62B, digital interpolation circuitry 62B, or interpolator 62B. Auxiliary interpolation path 64B may include digital circuitry and is sometimes also referred to herein as auxiliary or secondary interpolation circuitry 64B, auxiliary interpolation chain 64B, digital interpolation circuitry 64B, or interpolator 64B.

In the example of FIG. 4, upconversion circuitry 56A includes a first RFDAC and upconversion circuitry 56B includes a second RFDAC. Each RFDAC may perform both analog-to-digital conversion and upconversion, based on local oscillator signals from LO circuitry 52, to radio frequencies. This example is illustrative and non-limiting. Alternatively, each RFDAC may be replaced with a DAC that performs analog-to-digital conversion and a separate mixer that performs upconversion, based on local oscillator signals from LO circuitry 52, to radio frequencies.

The LO crosstalk mitigation circuitry in transceiver 28 may also include control circuitry 76 (e.g., formed from part of control circuitry 14 of FIG. 1 or other control circuitry in device 10). Control circuitry 76 (sometimes also referred to herein as controller 76 or processing circuitry 76) may be coupled to auxiliary interpolation path 64A and auxiliary interpolation path 64B over one or more control paths such as control path 67. Control circuitry 76 may receive or identify the frequency F1 of the local oscillator signal LO1 used by transmit chain 60A and may receive or identify the frequency F2 of the local oscillator signal LO2 used by transmit chain 60B. Control circuitry 76 may, for example, receive information identifying frequency F1 from DFE 54A over control path 74A, may receive information identifying frequency F1 from the baseband circuitry coupled to path 34A, may receive information identifying frequency F1 from LO circuitry 52 over control path 74, and/or may receive local oscillator signal LO1 at frequency F1 from LO circuitry 52 over control path 74. At the same time, control circuitry 76 may receive information identifying frequency F2 from DFE 54B over control path 74B, may receive information identifying frequency F2 from the baseband circuitry coupled to path 34B, may receive information identifying frequency F2 from LO circuitry 52 over control path 74, and/or may receive local oscillator signal LO2 at frequency F2 from LO circuitry 52 over control path 74.

Control circuitry 76 may generate control signal CTRL based on frequency F1 and frequency F2. Control signal CTRL may, for example, include or identify the spur frequency spacing dF associated with LO-to-LO crosstalk between transmit chains 60A and 60B. Control circuitry 76 may identify (e.g., detect, compute, estimate, generate, etc.) spur frequency spacing dF by generating (e.g., computing, identifying, determining, estimating, calculating, etc.) the greatest common divisor of frequencies F1 and F2, for example. Control circuitry 76 may transmit control signal CTRL to auxiliary interpolation path 64A and auxiliary interpolation path 64B over control path 67. Control circuitry 76 may use control signal CTRL to adjust, operate, control, and/or set one or more circuit components of auxiliary interpolation path 64A and one or more circuit components of auxiliary interpolation path 64B (e.g., based on the identified spur frequency spacing dF).

During signal transmission, DFE 54A may process baseband signal bbsig1 and may transmit the processed baseband signal to primary interpolation path 62A over transmit path 66A. Primary interpolation path 62A may process the signal received from DFE 54A and may output the signal onto transmit path 68A as transmit signal tx1. Transmit signal tx1 may be at the same frequency as baseband signal bbsig1 or may be at a higher frequency than baseband signal bbsig1 (e.g., given by the sample rate of primary interpolation path 62A). For example, circuitry in DFE 54A and/or primary interpolation path 62A may perform one or more sampling (e.g., oversampling) operations, interpolation operations, crest factor reduction operations, filtering operations, and/or any other desired operations on the signal (e.g., to prepare transmit signal tx1 for subsequent digital-to-analog conversion and upconversion to radio frequencies by upconversion circuitry 56A).

At the same time, primary interpolation path 62A (or transmit path 66A) may pass transmit signal tx1 (or the processed baseband signal output by DFE 54A) onto signal path 70A. Control signal CTRL may control auxiliary interpolation path 64A to sample and/or interpolate this signal using a different sample rate than primary interpolation path 62A, such as a sample rate associated with (e.g., equal to) the identified spur frequency spacing dF, which causes the auxiliary interpolation path to output a spur correction signal tx1′. Auxiliary interpolation path 64A may also apply a phase shift and optionally power scaling to spur correction signal tx1′.

Adder 72A may add the transmit signal tx1 on transmit path 68A to the spur correction signal tx1′ on signal path 70A to output a combined signal (e.g., tx1+tx1′) that is supplied to the input of upconversion circuitry 56A. Upconversion circuitry 56A may perform digital-to-analog conversion on the combined signal and may upconvert the combined signal to radio frequencies using local oscillator signal LO1, producing a radio-frequency signal rfsig1 at a carrier frequency equal to frequency F1 on radio-frequency transmission line path 36A.

LO-to-LO crosstalk may cause upconversion circuitry 56A to produce spurs upon converting the transmit signal tx1 in the combined signal received from adder 72A using local oscillator signal LO1. However, at the same time, the spur correction signal tx1′ in the combined signal received from adder 72A causes upconversion circuitry 56A to produce spurs, upon converting the combined signal, that are at the same frequencies but that are out of phase with the spurs produced from converting the transmit signal tx1 in the combined signal received from adder 72A. These phase shifted spurs may cancel out the spurs produced upon converting the transmit signal tx1 in the combined signal, such that the radio-frequency signal rfsig1 output by upconversion circuitry 56A does not include spurs produced by LO-to-LO cross talk.

At the same time, DFE 54B may process baseband signal bbsig2 and may transmit the processed baseband signal to primary interpolation path 62B over transmit path 66B. Primary interpolation path 62B may process the signal received from DFE 54B and may output the signal onto transmit path 68B as transmit signal tx2. Transmit signal tx2 may be at the same frequency as baseband signal bbsig2 or may be at a higher frequency than baseband signal bbsig2. For example, circuitry in DFE 54B and/or primary interpolation path 62B may perform one or more sampling (e.g., oversampling) operations, interpolation operations, crest factor reduction operations, filtering operations, and/or any other desired operations on the signal (e.g., to prepare transmit signal tx2 for subsequent digital-to-analog conversion and upconversion to radio frequencies by upconversion circuitry 56B).

At the same time, primary interpolation path 62B (or transmit path 66B) may pass transmit signal tx2 (or the processed baseband signal output by DFE 54B) onto signal path 70B. Control signal CTRL may control auxiliary interpolation path 64B to sample and/or interpolate the signal using a different sample rate than primary interpolation path 62B, such as a sample rate associated with (e.g., equal to) the identified spur frequency spacing dF, which causes the auxiliary interpolation path to output a spur correction signal tx2′. Auxiliary interpolation path 64B may also apply a phase shift and optionally power scaling to spur correction signal tx2′. Adder 72B may add the transmit signal tx2 on transmit path 68B to the spur correction signal tx2′ on signal path 70B to output a combined signal (e.g., tx2+tx2′) that is supplied to the input of upconversion circuitry 56B. Upconversion circuitry 56B may perform digital-to-analog conversion on the combined signal and may upconvert the combined signal to radio frequencies using local oscillator signal LO1, producing a radio-frequency signal rfsig2 at a carrier frequency equal to frequency F2 on radio-frequency transmission line path 36B.

LO-to-LO crosstalk may cause upconversion circuitry 56B to produce spurs upon converting transmit signal tx2 in the combined signal received from adder 72B. However, at the same time, the spur correction signal tx2′ in the combined signal received from adder 72B causes upconversion circuitry 56B to produce spurs, upon converting the combined signal, that are at the same frequencies but that are out of phase (e.g., 180 degrees out of phase) with respect to the spurs produced from converting the transmit signal tx2 in the combined signal received from adder 72B. These phase shifted spurs may cancel out the spurs produced upon converting the transmit signal tx2 in the combined signal, such that the radio-frequency signal rfsig2 output by upconversion circuitry 56B does not include spurs produced by LO-to-LO cross talk.

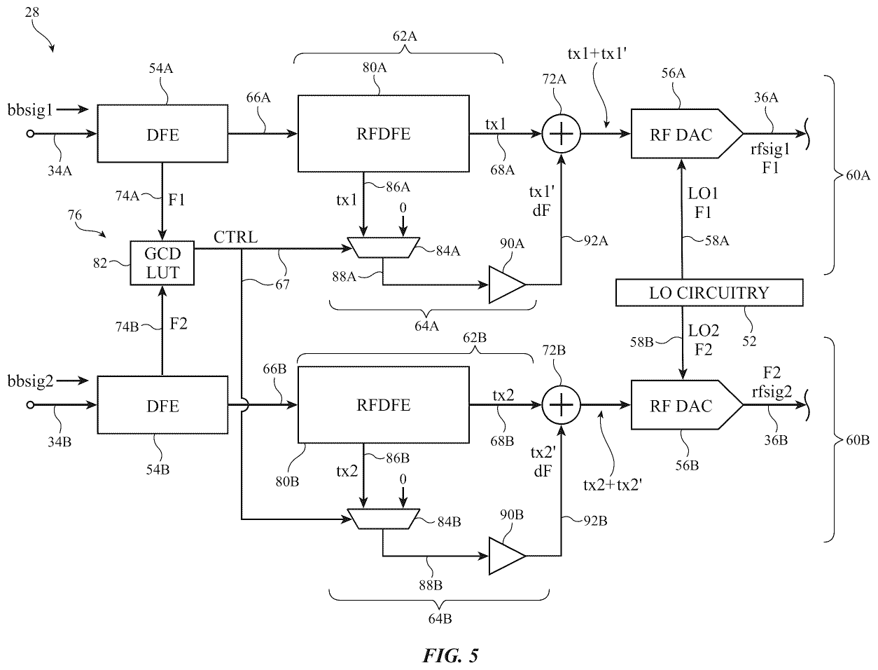

Primary interpolation paths 62 and auxiliary interpolation paths 64 may include any desired digital circuitry. FIG. 5 is a circuit diagram showing one exemplary implementation in which primary interpolation paths include radio-frequency digital front ends (RFDFEs) and in which auxiliary interpolation paths 64B include multiplexer circuitry. As shown in FIG. 5, primary interpolation path 62A may include RFDFE circuitry such as RFDFE 80A. Auxiliary interpolation path 64A may include multiplexer circuitry such as multiplexer 84A and may include signal processing circuitry such as circuitry 90A.

Multiplexer 84A may have a first input coupled to RFDFE 80A or transmit path 66A over signal path 86A. Multiplexer 84A may have a second input that receives a digital bit representing logic “0” (e.g., a voltage of zero volts, another reference voltage, or a digital zero bit). Multiplexer 84A may have an output coupled to an input of circuitry 90A over signal path 88A. Multiplexer 84A may have a control input (terminal) coupled to control circuitry 76 over control path 67. The output of circuitry 90A may be coupled to the second input of adder 72A over signal path 92A. Signal path 86A, multiplexer 84A, signal path 88A, circuitry 90A, and signal path 92A may collectively form signal path 70A of FIG. 5. Multiplexer 84A, circuitry 90A, and signal path 88A may collectively form auxiliary interpolation path 64A. Circuitry 90A may include amplifier circuitry, signal attenuator circuitry, and/or phase shifter circuitry.

Control circuitry 76 may include, for example, one or more lookup tables such as greatest common divisor (GCD) lookup table (LUT) 82. GCD LUT 82 may, for example, store GCD values for different combinations of frequencies F1 and F2. Controller 76 may identify spur frequency spacing dF based on frequencies F1 and F2 by looking up the GCD of frequencies F1 and F2 in GCD LUT 82 and may generate a corresponding control signal CTRL based on the GCD of frequencies F1 and F2.

During signal transmission, RFDFE 80A may sample the signal output by DFE 54A at a first sample rate, producing transmit signal tx1. This sampling (e.g., oversampling) may cause transmit signal tx1 to be at a higher frequency (sample rate) than the signal output by DFE 54A and at a lower frequency than radio-frequency signal rfsig1. At the same time, control signal CTRL may control multiplexer 84A to sample the same signal at a second sample rate that is lower than the first sample rate. The second sample rate may be associated with (e.g., equal to) the spur frequency spacing dF identified using GCD LUT 82.

Control signal CTRL may, for example, toggle multiplexer 84A between coupling its first input (signal path 86A) to its output (signal path 88A) and coupling its second input (a zero bit) to its output over time. When the first input is coupled to the output of multiplexer 84A (e.g., in a first state of multiplexer 84A), multiplexer 84A samples transmit signal tx1, passing a corresponding sample of the signal onto signal path 88A. When the second input is coupled to the output of multiplexer 84A (e.g., in a second state of multiplexer 84A), multiplexer 84A inserts one or more zero bits between the samples passed onto signal path 88A. Control signal CTRL may control multiplexer 84A to toggle between the first and second states at a sample rate equal to the identified spur frequency spacing dF, producing spur correction signal tx1′ at a frequency or sample rate equal to the identified spur frequency spacing dF.

Consider an example in which upconversion circuitry 56A outputs radio-frequency signal rfsig1 at a frequency F1=2 GHz and in which upconversion circuitry 56B outputs radio-frequency signal rfsig2 at a frequency F2=2.2 GHz. In this example, spur frequency spacing dF is equal to F2−F1=200 MHz. RFDFE 80A may sample the signal output by DFE 54A at a first sample rate that prepares transmit signal tx1′ for subsequent upconversion to 2 GHz by upconversion circuitry 56A. For every ten samples of transmit signal tx1′, multiplexer 84A may pass one sample onto signal path 88A from its first input, and then passes a series of nine zeros from its second input onto signal path 88A (e.g., between consecutive samples from signal path 86A). This produces a spur correction signal tx1′ at a sample rate equal to spur frequency spacing dF such that, when upconversion circuitry 56A upconverts the component of the combined signal formed from spur correction signal tx1′, the conversion will produce a set of spurs every 200 MHz in frequency space. These spurs align in frequency with spurs produced by upconversion circuitry 56A upon upconverting the component of the combined signal formed from transmit signal tx1. However, because the spurs produced by upconverting spur correction signal tx1′ are out of phase with respect to the spurs produced by upconverting transmit signal tx1, the spurs will cancel out in the radio-frequency signal rfsig1 output by upconversion circuitry 56A.

At the same time, RFDFE 80B may sample the signal output by DFE 54B at a third sample rate, producing transmit signal tx2. This sampling (e.g., oversampling) may cause transmit signal tx2 to be at a higher frequency (e.g., sample rate) than the signal output by DFE 54B and at a lower frequency than radio-frequency signal rfsig2. Control signal CTRL may control multiplexer 84B to sample the same signal at the second sample rate (e.g., equal to the spur frequency spacing dF identified using GCD LUT 82). Control signal CTRL may, for example, toggle multiplexer 84B between coupling its first input (signal path 86B) to its output (signal path 88B) and coupling its second input (a zero bit) to its output over time. When the first input is coupled to the output of multiplexer 84B (e.g., in a first state of multiplexer 84B), multiplexer 84B samples transmit signal tx2, passing a corresponding sample of the signal onto signal path 88B. When the second input is coupled to the output of multiplexer 84B (e.g., in a second state of multiplexer 84B), multiplexer 84B inserts one or more zero bits between the samples passed onto signal path 88B. Control signal CTRL may control multiplexer 84B to toggle between the first and second states at a sample rate equal to the identified spur frequency spacing dF, producing spur correction signal tx2′ at a frequency corresponding to the identified spur frequency spacing dF. Multiplexers 84A and 84B are sometimes also referred to herein as sampling circuits 84A and 84B.

Consider the example in which upconversion circuitry 56B outputs radio-frequency signal rfsig2 at a frequency F2=2.2 GHz and in which upconversion circuitry 56A outputs radio-frequency signal rfsig1 at a frequency F1=2 GHz. In this example, spur frequency spacing dF is equal to F2−F1=200 MHz. RFDFE 80B may sample the signal output by DFE 54B at a third sample rate that prepares transmit signal tx2′ for subsequent upconversion to 2.2 GHz by upconversion circuitry 56B. For every ten samples of transmit signal tx2′, multiplexer 84B may pass one sample onto signal path 88B from its first input and then a series of nine zeros from its second input. This produces a spur correction signal tx2′ associated with spur frequency spacing dF such that, when upconversion circuitry 56B upconverts the component of the combined signal formed from spur correction signal tx2', the conversion will produce a set of spurs every 200 MHz in frequency space. These spurs align in frequency with spurs produced by upconversion circuitry 56B upon upconverting the component of the combined signal formed from transmit signal tx2. However, because the spurs produced by upconverting the portion of the combined signal formed from spur correction signal tx2′ are out of phase with respect to the spurs produced by upconverting the portion of the combined signal formed from transmit signal tx2, the spurs will cancel out in the radio-frequency signal rfsig2 output by upconversion circuitry 56B.

Repeated spectra or aliasing at the output of the upconversion circuitry may be the undesired byproduct of the digital representation of the analog signal sign. In this way, the auxiliary interpolation paths of transmit chains 60A and 60B may generate spur correction signals having sample rates equal to spur frequency spacing dF (e.g., by resampling the transmit signals at sample rates equal to spur frequency spacing dF using multiplexers 84), may scale and phase shift the spur correction signals (e.g., using circuitry 90), and may add the scaled and phase shifted spur correction signals back to the signal output by the primary interpolation paths (e.g., using adders 72). The opposite phase of the spur correction signal relative to the signal on the primary interpolation path causes the spurs produced by upconversion circuitry 56 to cancel out at the output of transceiver 28.

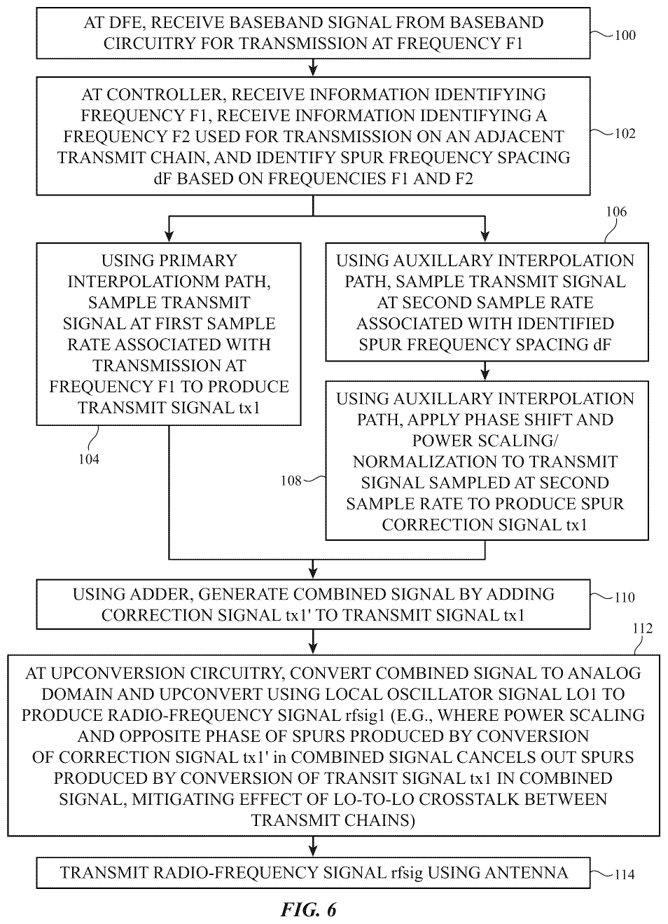

FIG. 6 is a flow chart of illustrative operations that may be performed by wireless circuitry 24 to transmit a crosstalk-mitigated radio-frequency signal rfsig1 using transmit chain 60A (FIGS. 4 and 5) and antenna 42A (FIG. 3). The operations of FIG. 6 may also be concurrently performed by other transmit chains and antennas in device 10.

At operation 100, DFE 54A may receive baseband signal bbsig1 from baseband circuitry for transmission at frequency F1. DFE 54A may perform any desired processing and/or sampling operations on the baseband signal to prepare the signal for upconversion to frequency F1.

At operation 102, control circuitry 76 (sometimes also referred to herein as LO crosstalk mitigation controller 76) may receive information identifying frequency F1 and identifying frequency F2 (e.g., as used by an adjacent, nearby, or coextensive transmit chain such as transmit chain 60B of FIGS. 3-5). Control circuitry 76 may identify spur frequency spacing dF based on the identified frequencies F1 and F2 (e.g., using GCD LUT 82 of FIG. 5). Control circuitry 76 may, for example, identify spur frequency spacing dF as the GCD of frequencies F1 and F2 (e.g., dF=GCD(F1, F2)). Processing may then proceed to operations 104 and 106 in parallel.

At operation 104, which may be performed prior to, concurrent with, between, and/or after operations 106 and/or 108, primary interpolation path 62A (e.g., RFDFE 80A) may sample the output of DFE 54 at a first sample rate associated with transmission at frequency F1. This sampling operation may produce transmit signal tx1 on transmit path 68A.

At operation 106, auxiliary interpolation path 64A may sample the output of DFE 54 (or transmit signal tx1) at a second sample rate different than the first sample rate. The second sample rate may be associated with (e.g., equal to) the identified spur frequency spacing dF. Control circuitry 76 may, for example, use control signal CTRL to control multiplexer 84A to sample transmit signal tx1 at the second sample rate.

At operation 108, auxiliary interpolation path 64A (e.g., circuitry 90A of FIG. 5) may apply a phase shift to the sampled signal, which may cause the sampled signal produced by the auxiliary interpolation path to be 180 degrees out of phase with respect to the sampled signal produced by the primary interpolation path. If desired, auxiliary interpolation path 64A (e.g., circuitry 90A) may perform power scaling and/or normalization on the sampled signal (e.g., aligning the signal level of the sampled signal produced by the auxiliary interpolation path with the signal level of the sampled signal produced by the primary interpolation path). Auxiliary interpolation path 64A may output the sampled, phase shifted, and scaled signal as spur correction signal tx1′ (e.g., at a frequency or sample rate equal to spur frequency spacing dF).

At operation 110, adder 72A may generate a combined signal by adding the transmit signal tx1 sampled by primary interpolation path 62A to the spur correction signal tx1′ sampled, shifted, and scaled by auxiliary interpolation path 64A.

At operation 112, upconversion circuitry 56A may convert the combined signal output by adder 72A to the analog domain. Upconversion circuitry 56A may also upconvert the combined signal using local oscillator signal LO1 at frequency F1 to produce radio-frequency signal rfsig1 (e.g., having wireless data from transmit signal tx1 modulated onto a carrier at frequency F1). Any spurs produced by converting the transmit signal (tx1) component of the combined signal are canceled out by out-of-phase spurs produced by converting the correction signal (tx1') component of the combined signal, causing radio-frequency signal rfsig1 to include a signal peak at frequency F1 without LO crosstalk spurs at other frequencies (e.g., frequencies FX separated by spur frequency spacing dF). This may effectively mitigate LO-to-LO crosstalk in transceiver 28.

At operation 114, radio-frequency transmission line path 36A may transmit radio-frequency signal rfsig1 to antenna 42A. Antenna 42A may transmit/radiate radio-frequency signal rfsig1.

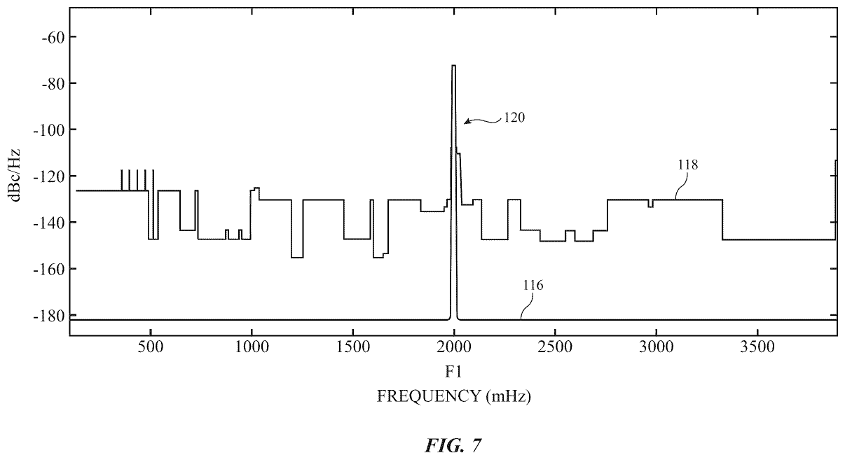

FIGS. 7-10 illustrate the operation of transmit chain 60A in generating radio-frequency signal rfsig1. Curve 116 of FIG. 7 plots signal level as a function of frequency of the radio-frequency signal rfsig1 output by upconversion circuitry 56A in the absence of LO-to-LO crosstalk. As shown by curve 116, radio-frequency signal rfsig1 exhibits a sharp and narrow peak 120 at frequency F1 (e.g., a carrier frequency of radio-frequency signal rfsig1). Peak 120 may be modulated with wireless data from baseband signal bbsig1.

FIGS. 7, 8, and 10 also illustrate an example of an RF emissions mask 118 imposed on wireless circuitry 24. Emissions mask 118 represents an upper limit on radio-frequency radiation, emission, exposure, and/or absorption imposed on wireless circuitry 24 (e.g., a maximum permissible exposure (MPE) limit, specific absorption rate (SAR) limit, etc.). Emissions mask 118 may be imposed by a manufacturer of device 10, a regulatory body, an industry standard, etc. As shown by curve 116 of FIG. 7, in the absence of LO-to-LO crosstalk, radio-frequency signal rfsig1 remains below emissions mask 118 at all frequencies (e.g., wireless circuitry 24 complies with a corresponding regulatory limit or requirement).

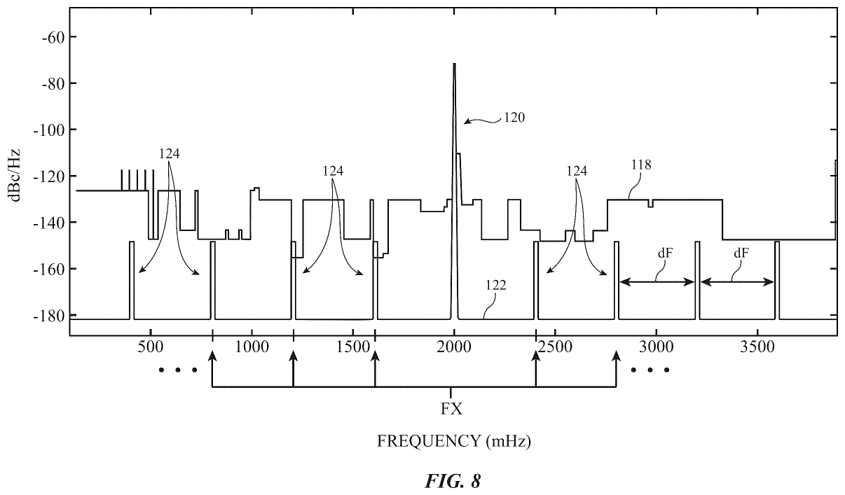

Curve 122 of FIG. 8 plots signal level as a function of frequency of the radio-frequency signal rfsig1 output by upconversion circuitry 56A in the presence of LO-to-LO crosstalk and without performing crosstalk mitigation. As shown by curve 122, the LO crosstalk causes upconversion circuitry 56A to produce a series, set, or comb of spurs 124 at frequencies FX around the modulated frequency F1. Adjacent spurs 124 (adjacent frequencies FX) are separated by spur frequency spacing dF, which is equal to the GCD of frequencies F1 and F2.

One or more of spurs 124 may exceed emissions mask 118 (see, e.g., the first two spurs 124 below frequency F1 in FIG. 8), causing wireless circuitry 24 to violate the corresponding regulatory limit or requirement.

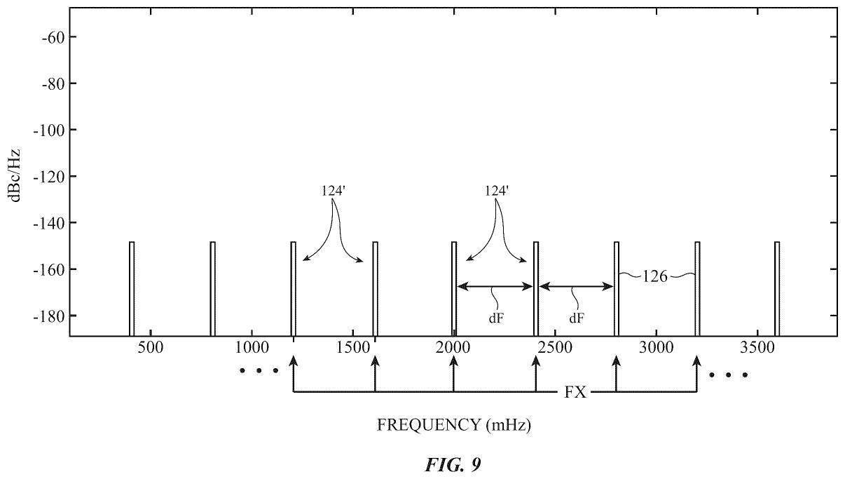

Curve 126 of FIG. 9 corresponds to spur correction signal tx1′, plotting the output of upconversion circuitry 54A produced by converting the spur correction signal tx1′ in the combined signal output by adder 72A. Auxiliary interpolation path 64B samples the transmit signal at the second sample rate equal to spur frequency spacing dF, which causes upconversion circuitry 56A to produce spurs 124′ in curve 126 at frequencies FX separated by spur frequency spacing dF (e.g., the same frequencies FX as the spurs 124 in curve 122 of FIG. 8). Spurs 124′ are 180 degrees out of phase with respect to the spurs 124 in curve 126 (e.g., due to phase shifting performed by auxiliary interpolation path 64B).

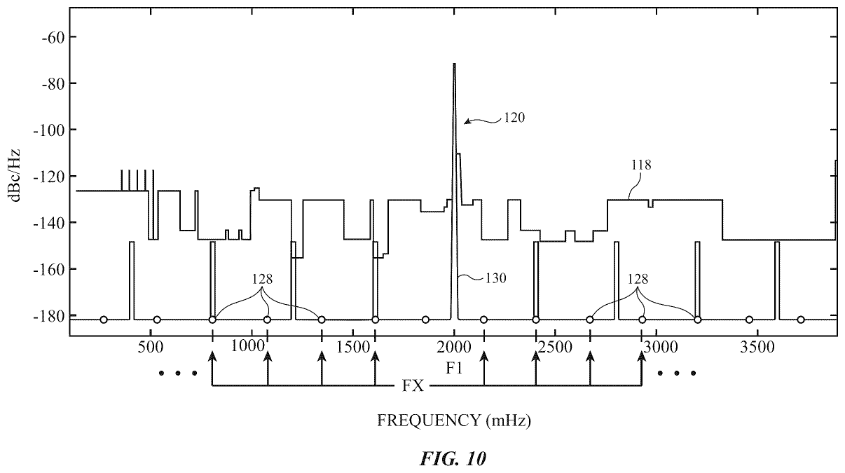

Curve 130 of FIG. 10 plots the signal level of the radio-frequency signal rfsig1 output by upconversion circuitry 56A upon converting the combined signal output by adder 72A. As shown by points 128 along curve 130, the phase difference between spurs 124′ in curve 126 of FIG. 9 and spurs 124 in curve 122 of FIG. 8 causes spurs 124′ to cancel out with spurs 124 in radio-frequency signal rfsig1. This prevents radio-frequency signal rfsig1 from including any spurs that exceed emissions mask 118, which may help to ensure that wireless circuitry 24 continues to satisfy corresponding regulatory limits/regulations.

The example of FIGS. 7-10 is illustrative and non-limiting. Curves 116-130 may have other shapes in practice. Transmit chain 60A may transmit radio-frequency signal rfsig1 at any desired carrier frequency. If desired, primary interpolation path 62A may include circuitry that phase shifts transmit signal tx1 and/or that power scales transmit signal tx1 as needed to cancel out LO crosstalk upon conversion by upconversion circuitry 56A (e.g., in addition to phase shifting and scaling performed by auxiliary interpolation path 64A or instead of phase shifting and scaling in auxiliary interpolation path 64A).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above in connection with FIGS. 1-10 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. Wireless circuitry comprising:
a digital front end configured to receive a baseband signal;
upconversion circuitry;
an adder coupled to an input of the upconversion circuitry; and
first and second interpolation paths coupled in parallel between the digital front end and the adder wherein
the first interpolation path is configured to generate a first signal at a first sample rate based on the baseband signal,
the second interpolation path is configured to generate a second signal at a second sample rate lower than the first sample rate based on the baseband signal, the second signal being out of phase with respect to the first signal,
the adder is configured to generate a combined signal based on the first and second signals, and
the upconversion circuitry is configured to generate a radio-frequency signal based on the combined signal and a local oscillator signal.

2. The wireless circuitry of claim 1, wherein the second interpolation path is configured to shift a phase of the second signal and is configured to scale a power of the second signal.

3. The wireless circuitry of claim 1, wherein the upconversion circuitry comprises a digital-to-analog converter (DAC) and a mixer coupled in series between the adder and a radio-frequency transmission line path.

4. The wireless circuitry of claim 1, wherein the upconversion circuitry comprises a radio-frequency digital-to-analog converter (RFDAC).

5. The wireless circuitry of claim 1, wherein the second interpolation path comprises a multiplexer having a first input communicatively coupled to the digital front end, a second input that receives a digital zero bit, and an output communicatively coupled to the adder.

6. The wireless circuitry of claim 5, wherein the multiplexer has a first state in which the first input is coupled to the output of the multiplexer, the multiplexer has a second state in which the second input is coupled to the output of the multiplexer, and the wireless circuitry further comprises:
control circuitry configured to toggle the multiplexer between the first and second states at the second sample rate.

7. The wireless circuitry of claim 6, wherein the second interpolation path further comprises a phase shifter coupled between the output of the multiplexer and the adder.

8. The wireless circuitry of claim 1, further comprising:
an additional digital front end configured to receive an additional baseband signal;
additional upconversion circuitry configured to generate an additional radio-frequency signal based on the additional baseband signal and an additional local oscillator signal, wherein the local oscillator signal is at a first frequency and the additional local oscillator signal is at a second frequency different than the first frequency.

9. The wireless circuitry of claim 8, wherein the second sample rate is based on the first frequency and the second frequency.

10. The wireless circuitry of claim 9, wherein the second sample rate is equal to a greatest common divisor of the first frequency and the second frequency.

11. The wireless circuitry of claim 8, further comprising:
an additional adder coupled to an input of the additional upconversion circuitry; and
third and fourth interpolation paths coupled in parallel between the additional digital front end and the additional adder, wherein
the third interpolation path is configured to generate a third signal at a third sample rate based on the additional baseband signal,
the fourth interpolation path is configured to generate a fourth signal at a fourth sample rate lower than the third sample rate based on the additional baseband signal, the fourth signal being out of phase with respect to the third signal,
the additional adder is configured to generate an additional combined signal based on the third and fourth signals, and
the additional upconversion circuitry is configured to generate the additional radio-frequency signal based on the additional combined signal.

12. The wireless circuitry of claim 11, wherein the fourth sample rate is equal to the second sample rate and the second sample rate is equal to a greatest common divisor of the first frequency and the second frequency.

13. The wireless circuitry of claim 12, further comprising:
a first antenna;
a first radio-frequency transmission line path that couples the upconversion circuitry to the first antenna;
a second antenna; and
a second radio-frequency transmission line path that couples the additional upconversion circuitry to the second antenna.

14. A transceiver comprising:
local oscillator (LO) circuitry configured to generate a first LO signal at a first frequency and a second LO signal at a second frequency different from the first frequency;
a first transmit chain operably coupled to the LOC circuitry and configured to generate a first radio-frequency signal at the first frequency based on the first LO signal; and
a second transmit chain operably coupled to the LOC circuitry, wherein the second transmit chain includes
first sampling circuitry configured to generate a first signal at a first sample rate based on a baseband signal,
second sampling circuitry configured to generate a second signal at a second sample rate lower than the first sample rate based on the baseband signal, wherein the second signal is out of phase with the first signal,
an adder configured to generate a combined signal by adding the second signal to the first signal, and
upconversion circuitry configured to generate a second radio-frequency signal at the second frequency based on the second LO signal and the combined signal.

15. The transceiver of claim 14, wherein the second sample rate is equal to a greatest common divisor of the first frequency and the second frequency.

16. The transceiver of claim 15, further comprising:
a lookup table that stores greatest common divisors for different combinations of the first frequency and the second frequency; and
control circuitry configured to control the second sampling circuitry to adjust the second sample rate based on the lookup table.

17. The transceiver of claim 16, further comprising:
circuitry coupled between the second sampling circuitry and the adder, wherein the circuitry is configured to shift a phase of the second signal and is configured to scale a power of the second signal.

18. The transceiver of claim 15, wherein the second sampling circuitry comprises:
a multiplexer configured to pass samples of the second signal to the adder at the second sample rate and configured to insert zero bits between the samples passed to the adder.

19. A method of operating radio-frequency transceiver circuitry, comprising:
transmitting, using a first transmit chain, a first radio-frequency signal at a first frequency; and
transmitting, using a second transmit chain, a second radio-frequency signal at a second frequency different than the first frequency, wherein transmitting the second radio-frequency signal includes
sampling, using first interpolation circuitry, a signal at a first sample rate,
sampling, using second interpolation circuitry, the signal at a second sample rate lower than the first sample rate, wherein the signal sampled by the second interpolation circuitry is out of phase with the signal sampled by the first interpolation circuitry,
generating, using an adder, a combined signal based on the signal sampled by the first interpolation circuitry and the signal sampled by the second interpolation circuitry, and
generating, using conversion circuitry, the second radio-frequency signal based on the combined signal.

20. The method of claim 19, further comprising:
clocking, using local oscillator (LO) circuitry, the first transmit chain using a first LO signal at the first frequency; and
clocking, using the LO circuitry, the upconversion circuitry in the second transmit chain using a second LO signal at the second frequency, wherein the second sample rate is equal to a greatest common divisor of the first and second frequencies and generation of the second radio-frequency signal based on the combined signal mitigates signal spurs in the second radio-frequency signal associated with crosstalk between the first and second LO signals.
